(19) United States
(12) Patent Application Publication
(10) Pub. No.: US 2009/0077386 A1
(43) Pub. Date: Mar. 19, 2009

(54) NOTARY ENFORCEMENT - FRAUD PREVENTION

(76) Inventor: Jeffrey Alan Simonian, Huntington Beach, CA (US)

Correspondence Address: THE PATEL LAW FIRM, P.C., 2532 DUPONT DRIVE, IRVINE, CA, 92612, US

(21) Appl. No.: 12/326,866

(22) Filed: Dec. 2, 2008

Related U.S. Application Data
(63) Continuation-in-part of application No. 12/156,921, filed on Jun. 5, 2008.
(60) Provisional application No. 60/933,756, filed on Jun. 8, 2007.

(51) Int. Cl. H04L 9/00

(52) U.S. Cl. 713/176

(57) ABSTRACT

A system for electronically signing a document and verifying the signor's identity includes a computer having a processor, an input device, and a memory. A biometric scanner is in electronic communication with the computer for scanning at least one biometric feature of a signor. An instruction set is stored within the memory for execution by the processor wherein execution of at least a portion of the instruction set operates to create an electronic signature and integrates at least one biometric characteristic of the biometric feature within the electronic signature.

### CROSS REFERENCE TO RELATED APPLICATIONS

This utility patent application is a continuation-in-part of pending U.S. patent application entitled “NOTARY ENFORCEMENT—FRAUD PREVENTION” by the same inventor, Ser. No. 12/156,921, filed Jun. 5, 2008, and claims the benefit under 35 U.S.C. 119(e) of U.S. provisional patent application entitled “NOTARY ENFORCEMENT—ELECTRONIC SIGNING, VIDEO WITNESSING AND BIO-METRIC PRINT RECORDING ELECTRONICALLY AND STORING TO PREVENT FRAUD AND FORGERY” by the same inventor, filed Jun. 8, 2007, Ser. No. 60/933,756, now expired, the disclosure of each of the aforementioned applications being incorporated herein in its entirety by reference.

### COPYRIGHT NOTICE

Portions of the disclosure of this patent document may contain material that is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### BACKGROUND OF THE INVENTION

1. Field of the Invention

This invention generally relates to electronic signatures and, more particularly, to a system for electronically obtaining the identity and signature of a person executing a legal document.

2. Discussion of the Related Art

While notaries public have been verifying and validating identities for decades, fraud and forgeries continue to be problematic in the signing and witnessing of legal documents. Such legal documents extend across a wide variety of disciplines in everyday life, examples of which are documents related to real estate transactions. Enterprises, law enforcement and courts are routinely challenged to verify and corroborate the validity of signatures on documents in this age of identity theft, misuse and forgery.

The introduction of computers and electronics into everyday commerce and life has caused enterprises and government to move from paper-based systems to more economical paperless environments. With this new technology, new barriers are presented that must be overcome to ensure the validity of electronically stored documents. Business transactions, agreements, real estate transactions, validation and authorizations are some examples of events that require one or more person's assent as evidenced by that person's signature. These documents and signatures must be electronically perpetuated in a paperless system to maintain the commercial quality or permanence that is required to support audit, evidentiary and enforcement requirements.

In October 2000, the federal Electronic Signatures in Global and National Commerce Act (also known as “E-Sign”) was signed into law. That new law broadly authorizes electronic records and electronic signatures as being legally effective. The existence of this new law makes real estate and business transactions conducted electronically easier to procure. However, one of the major barriers for conducting electronic business transactions has been recording evidence of the signing, witnessing, and notarizing of the signature(s). As technology utilization increases in society, the frequency of electronic business transactions will inevitably increase. With that, the frequency and sophistication of fraud and forgery has grown exponentially and can be expected to continue at a growing pace.

Typically, electronic signatures are applied to electronic documents within a user's computer. After the electronic signature is appended to an electronic document, the electronic document is electronically transmitted to another computer, where the electronic document may be processed further or stored.

While many solutions have been found to store and process electronic documents with electronic signatures, problems still exist because many real estate and business transactions, although conducted electronically, still require a user to physically affix a user signature to a document, regardless of whether the document is in paper or electronic form. Translating a physical signature into an electronic signature and incorporating uniquely identifying features into the physical signature so it can be used to verify documents presents new problems to overcome.

More importantly the identity of the signor(s) is monumentally important and the integrity of the signing must be obtained in order to verify the document and its legal effect. One area requiring such verification is the real estate industry where a transaction routinely requires the signing, witnessing and notarization of many documents.

Providing reliably verified documents to public agencies such as law enforcement, judicial courts and the investigative arm of the U.S. Department of Justice will be of benefit. Private and/or government backed entities such as lending institutions and insurance enterprises will also benefit from having reliably verified documents. Further, the improved security of the signature process will significantly reduce the financial losses sustained in commerce as a result of illegal activity.

### SUMMARY

The present invention is directed to a system that creates a verifiable electronic signature for documents that includes biometric characteristics of the signor. The system includes a computer having a processor, an input device, and a memory. A biometric scanner is in electronic communication with the computer for scanning at least one biometric feature of a signor. An instruction set is stored within the memory for execution by the processor wherein execution of at least a portion of the instruction set operates to create an electronic signature and integrates at least one biometric characteristic of the biometric feature within the electronic signature.

Another aspect of the present invention is a method for electronically signing a document and verifying the signor's identity wherein the method includes establishing the identity of the document signor and recording a biometric feature of the document signor. At least a portion of the recorded biometric feature is digitized. An electronic signature is created and integrated with the digitized portion of the recorded biometric feature. The integrated signature is then affixed to the document.

### BRIEF DESCRIPTION OF THE DRAWINGS

For a fuller understanding of the nature of the present invention, reference should be made to the accompanying drawings in which:

FIG. 1 is a process flow diagram of the electronic capture and transmittal of a signature and fingerprint; and

FIG. 2 is a block schematic of an electronic signature and fingerprint capturing system according to the present invention.

### DETAILED DESCRIPTION OF THE PREFERRED EMBODIMENT

For purposes of description herein, one will understand that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific quantifications and other physical characteristics relating to the embodiments disclosed herein are not to be considered as limiting, unless the claims expressly state otherwise.

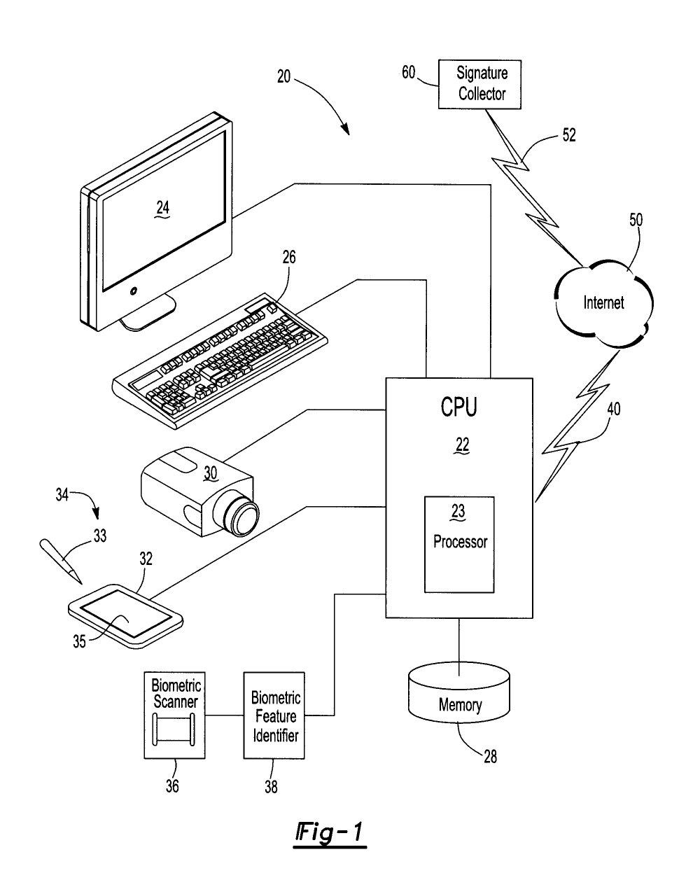

Referring to FIG. 1, a system 20 for electronically signing a document and verifying the signor's identity is shown. System 20 includes a computer 22 that has a processor 23, an input device 26 such as a keyboard, a display 24 and a memory 28. Memory 28 can retain therein an instruction set that can be recalled and executed by processor 23. Computer 22 also has an external communication connection 40 to the Internet 50 for communicating over links 52 with remote systems 60. Remote systems 60 can include systems used by parties for collecting signatures for documents parties desire to be legally executed utilizing the systems and methods described herein.

A biometric scanner 36 and a biometric feature identifier 38 are communicatively linked to computer 22. Biometric scanner 36 is utilized to scan a unique biometric feature of the signor to assist in identifying the signor. Biometric scanner 36 can be a fingerprint scanner on which the signor places either a thumb or finger for scanning. Biometric feature identifier 38 receives the scanned image from biometric scanner 36 and digitizes the scan. Instead of digitizing an entire scan, selected unique characteristics of the scan can be identified, digitized and placed in a file. Alternatively, biometric scanner 36 can be a retinal scanner to scan one or both of the signor's retinas, or the scanner can be an iris scanner to scan one or both irises of the signor.

A signature capturing device 34 is also communicatively connected to computer 22. As illustrated in FIG. 1, signature capturing device 34 includes a signature pad 32 and a stylus 33. At the time the signor is required to sign a document, in lieu of signing on a paper document, the signor can utilize stylus 33 to hand scribe a physical signature on a capturing surface 35 of signature pad 32. Capturing surface 35 is pressure sensitive and will capture a likeness of the signor's signature in the signor's handwriting. Signature capturing device 34 then digitizes the signature as an electronic file. The entire signature facsimile of the created file can be then attached to an electronic copy of the document being signed, or selected characteristics of the physical signature can be combined to represent the physical signature. While many signature pads in use today utilize relatively low resolution technology, signature capturing device 34 employs technology to record a high resolution digitization of the signor's signature. In lieu of signature capturing device 34 connected to computer 22, a tablet computer can be used wherein display 24 includes a touch sensitive screen that is responsive to entries hand scribed directly on the screen by utilizing a stylus.

As a further aid to the process of collecting document signatures, system 20 can also include a video camera 30 to establish video conferencing between the signor and one or more remote interested parties, during which verification of the signing will take place. One or more of the parties may be a party collecting the official signature for attachment to a document. Such documents can include real estate offer and acceptance documents, real estate closing documents, or other documents routinely utilized in commerce and requiring the official signature of a party to become valid and binding to the interested parties. One advantage of using video conferencing in system 20 is the increased convenience in scheduling a signing. A signor may set up an online appointment to verify a signing at times and places which are convenient for both the signor and the signing witnesses. While only video camera 30 is illustrated, it will be understood that such a link also includes an audio link that is either separate from or integrated with video camera 30. Any reference to video camera 30 is assumed to include a concurrent audio link for an audio-visual link to facilitate communication between linked parties. Video camera 30 is utilized to verify the identity of a document signor by comparing the video captured to a known picture of the signor. Alternatively, while live video is streamed or broadcast using video camera 30, the signor can display a government-issued identification such as a driver's license, allowing another party to the signing to compare the identification to the visual image of the signor in order to verify the signor's identity. Video camera 30 can also record the physical event of a signor executing a signature for affixation to one or more documents utilized in the transaction being witnessed.

The three identification elements, biometric scan, electronic signature and video identification are thus combined to verify both the authenticity of the signor, and the signor's signature. If an attempt to defraud or forge takes place, system 20 has captured not only the finger print or biometric feature of the signor and the signor's signature, but more importantly, the individual's facial picture and government-issued identification have also been captured via the video conferencing. Once system 20 captures and saves at least one of the three identification elements, they can be stored and used to auto-populate the remaining identification elements for comparison purposes in later transactions.

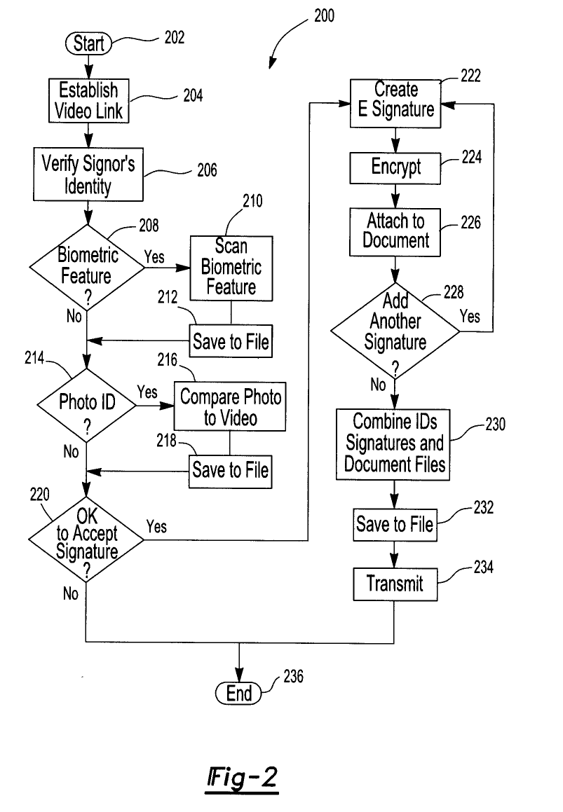

Referring now to FIG. 2, a flow chart illustrates a typical flow of a process 200 of remotely obtaining a desired signature of a party to a transaction and recording and affixing the signature to a document. Process 200 starts in block 202. Process 200 then proceeds to block 204. In block 204, the parties establish a video (and audio) link via video camera 30 through external communication connection 40 and Internet 50. After establishing a video (and audio) link, process 200 proceeds to block 206. In block 206, the identity of one or more parties is initially established. After the identity of one or more parties is established, process 200 proceeds to block 208. In block 208, the parties decide whether a biometric feature of the document signor is to be included in the electronic signature. If a biometric scan is not desired, process 200 proceeds directly to block 214. If a biometric feature is desired, process 200 moves to block 210 where the biometric feature (fingerprint, retinal scan, or iris pattern) is scanned by biometric scanner 36. In block 212, the scan is digitized and saved to a file at which time process 200 progresses to block 214.

At block 214, the parties decide whether to include picture/photo identification as part of the signature. If the picture identification is not desired, process 200 proceeds directly to block 220. If picture/photo identification is desired, process 200 moves to block 216 where a known photo of the signor is compared to the video feed from video camera 30. Alternatively, the comparison can be made by the signor holding a government-issued identification within the field of view of the video camera so that a party to the document execution can verify the identity of the individual according to the identification. The comparison can be accomplished by a responsible party to the transaction or alternatively by recognition software resident on one or more of the computer systems 20 or remote systems 60 linked via Internet 50. The comparison is then digitized and saved to file in block 218, whereupon process 200 moves to block 220.

In block 220, the parties determine whether identities are acceptably verified, and if so, process 200 progresses to block 222. If identities are not acceptably verified, the transaction can be aborted and process 200 ends at block 236. In block 222, the signor's electronic signature is created. Creation of the electronic signature can be accomplished by creating a digital signature utilizing key generation algorithms to generate a private and a public key and a signing algorithm to generate the signature. Methods of using digital signatures and algorithms to create a digital signature are known in the art and utilized here to generate a digital signature. However, an alternative to a digital signature is the digitization of the signor's hand scribed signature. Utilizing stylus 33, the signor hand scribes a signature on capturing surface 35 of signature pad 32. Signature pad 32 then digitizes the signature to an electronic file, or alternatively sends the captured signature to computer 22 where an instruction set creates a digital file of one or more characteristics of the captured signature. Once the electronic signature is created, process 200 proceeds to block 224. In block 224, the signature is encrypted for security purposes. Once the signature is encrypted, process 200 proceeds to block 226. In block 226, the encrypted signature is attached to the document. Those practiced in the art will recognize that prior to encryption of the digitized hand scribed signature, one or more biometric characteristics from the biometric and photo scans obtained in blocks 210 and 216 can be incorporated with the digitized signature to create an integrated signature. Once the encrypted signature is attached to the document, process 200 proceeds to block 228.

While the above steps describe the scanning of the signor's biometric feature, the creation of an electronic signature, and validation of the signor's identity via video conferencing as alternatives, those practiced in the art will understand that the intent of process 200 is to obtain all three identifiers to provide the most secure identification and verification of the signor's authenticity.

In block 228, the parties determine if another signature is to be included with the document. Additional signatures can be those of a party to the transaction such as a co-purchaser of property or those of witnesses to the document execution. If another signature is required, process 200 returns to block 222 to repeat blocks 222 through 228 until all desired signatures have been created and attached to the document. If all desired signatures have been created, process 200 continues to block 230.

In block 230, any unattached signatures, identity files, and document files can be combined to create the final executed document. Once the final executed document is created, process 200 proceeds to block 232. In block 232, the final executed document is then saved to file. The file can be stored in the respective computers utilized in the transaction or can be written to a portable medium such as, but limited to, a CD disk, a DVD disk, or to a secure flash memory card. Once the final executed document is saved to file, process 200 proceeds to block 234. In block 234, the executed document with the associated signature files can also be transmitted to interested third parties. Once the executed document is saved to file, and optionally transmitted, process 200 then ends at block 236.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

I claim:

1. A system for electronically signing a document and verifying the signor's identity, said system comprising:
a computer having a processor, an input device, and a memory;
a biometric scanner in electronic communication with said computer for scanning at least one biometric feature of a signor;
an instruction set stored within said memory for execution by said processor wherein execution of at least a portion of said instruction set operates to create an electronic signature and further wherein at least one biometric characteristic of said biometric feature is integrated within said electronic signature.

2. The system according to claim 1 wherein said electronic signature created by said instruction set is a digital signature.

3. The system according to claim 2 wherein said instruction set further includes instructions to encrypt said integrated electronic signature.

4. The system according to claim 1 further including a signature capturing device for digitizing a handwritten signature.

5. The system according to claim 3 wherein said instruction set operates to create a digitized signature from a handwritten signature captured by said signature capturing device.

6. The system according to claim 5 wherein said instruction set further includes instructions to encrypt said integrated electronic signature.

7. The system according to claim 3 wherein said signature capturing device includes a capturing surface and a stylus for hand scribing a signature on said capturing surface.

8. The system according to claim 1 wherein said biometric scanner is a fingerprint scanner.

9. The system according to claim 1 wherein said biometric scanner is a retina scanner.

10. The system according to claim 1 wherein said biometric scanner is an iris scanner.

11. A method for electronically signing a document and verifying the signor's identity, said method comprising:
establishing the identity of the document signor;
recording a biometric feature of the document signor;
digitizing at least a portion of the recorded biometric feature;
creating an electronic signature;
integrating the digitized portion of the recorded biometric feature with the electronic signature; and
affixing the integrated signature to the document.

12. The method according to claim 11 wherein said establishing step is accomplished via video conference.

13. The method according to claim 12 wherein said integrating step comprises:
Integrating the recorded biometric feature, the electronic signature and a recording of the video conference into an identification file for the signor.

14. The method according to claim 11 wherein said recording step records a fingerprint of the signor.

15. The method according to claim 11 wherein said recording step records a retinal pattern of the signor.

16. The method according to claim 11 wherein said recording step records an iris pattern of the signor.

17. The method according to claim 11 wherein said creating step creates a digital signature.

18. The method according to claim 11 wherein said creating step digitizes a handwritten signature of the signor.

19. The method according to claim 17 further including prior to said creating step, the step of hand scribing the signor's signature on a signature capturing device.

20. The method according to claim 11 further including after said integrating step, the step of encrypting the integrated electronic signature.
